(19) United States
(12) Patent Application Publication
(10) Pub. No.: US 2026/0065806 A1
(43) Pub. Date: Mar. 5, 2026

(54) MULTI-CHANNEL SPATIO-TEMPORAL TRANSFORMER BASED SIGN LANGUAGE GENERATION DEVICE, METHOD, RECORDING MEDIUM

(71) Applicant: AJOU UNIVERSITY INDUSTRY-ACADEMIC COOPERATION FOUNDATION, Suwon-si (KR)

(72) Inventors: Tae-Sun CHUNG, Seongnam-si (KR); Xiaohan MA, Suwon-si (KR); Rize JIN, Suwon-si (KR)

(21) Appl. No.: 19/319,527

(22) Filed: Sep. 4, 2025

(30) Foreign Application Priority Data
Sep. 4, 2024 (KR) 10-2024-0119677

(51) Int. Cl. G09B 21/00

(52) U.S. Cl. CPC G09B 21/009

(57) ABSTRACT

A multi-channel spatio-temporal transformer based sign language generation device includes a text encoder configured to output a contextual feature by inputting a text sequence prepared in advance into at least one encoder block, and a multi-channel spatio-temporal decoder configured to output a full-channel sign pose sequence including multiple channels for each body part for implementing sign language operations by extracting spatial attention features and temporal attention features from a sign pose sequence prepared in advance, and inputting the spatial/temporal attention features and the contextual features output from the text encoder into at least one module.

### CROSS REFERENCE TO RELATED APPLICATIONS

This application claims priority to Korean Patent Application No. 10-2024-0119677, filed on Sep. 4, 2024, in the Korean Intellectual Property Office, which is incorporated by reference herein in its entirety.

### FIELD OF THE INVENTION

The present disclosure relates to a multi-channel spatio-temporal transformer based sign language generation device, method and recording medium.

### BACKGROUND OF THE RELATED ART

The World Health Organization (WHO) estimates that about 5% of the world's population suffers from severe hearing loss. Although not used by all deaf people, sign language is the main form of communication medium for those with hearing impairments and is a natural language present in many societies around the world.

Unlike spoken language, sign language achieves communication through continuous movement across multiple channels such as the face, upper body, and hands, where each channel plays a pivotal role in sign language expression. In addition, the spatial composition, location, and temporal movement of these channels collectively form the grammar and semantic structure of sign language.

Meanwhile, the Sign Language Production (SLP) model refers to an operation of generating a sign language representation in a text representation in the form of a term or word sequence, and in the SLP model, the sign language may be expressed in various ways such as a sign pose sequence (skeletal joint coordinates), animation, and realistic video.

However, due to differences in tokenization and phonological properties between spoken and sign languages, the SLP model has difficulty accurately mapping simple text inputs to continuous sign pose sequences that represent changes across multiple visual channels. As a result, an unnatural sign language that does not match the actual human motion may be generated, and the sign language motion may be generated inconsistently or the order between the motions may be reversed, which may result in the meaning not being properly transmitted. This reduces the reliability and efficiency of sign language generation and can lead to poor communication.

Therefore, research on how to generate more accurate and expressive sign language is needed.

### SUMMARY OF THE INVENTION

The present disclosure has been devised to solve the above problems, and an objective of the present disclosure is to provide a multi-channel spatio-temporal transformer based sign language generation device, method and recording medium.

A multi-channel spatio-temporal transformer based sign language generation device according to an aspect of the present disclosure is provided for achieving the objective, the device including: a text encoder configured to output contextual features by inputting a pre-prepared text sequence to at least one encoder block, and a multi-channel spatio-temporal decoder configured to extract a spatial attention feature and a temporal attention feature from a pre-prepared sign pose sequence, input the spatial/temporal attention features and the contextual feature output from the text encoder to at least one module, and output a full-channel sign pose sequence including multiple channels for each body part for implementing a sign language operation.

The sign language generating method by the multi-channel spatio-temporal transformer based sign language generation device according to another aspect of the present disclosure is provided for achieving the objective, the method including: inputting, by a text encoder, a pre-prepared text sequence into at least one encoder block to output contextual features, and extracting, by a multi-channel spatio-temporal decoder, a spatial attention feature and a temporal attention feature from the prepared sign pose sequence, inputting the spatial/temporal attention feature and the contextual feature output from the text encoder into at least one module, and outputting a full-channel sign pose sequence including multiple channels for each body part for implementing a sign language operation.

According to one aspect of the present disclosure, the multi-channel spatio-temporal transformer based sign language generation device, method and recording medium are provided, thereby effectively transmitting non-verbal information such as emotion, emphasis, and questions, and the flow of operations and the transmission of meaning become natural and the meaning of sign language becomes clear.

In addition, it is possible to maximize the accuracy of the sign language, and to create a sign language that is more expressive.

### BRIEF DESCRIPTION OF THE DRAWINGS

FIG. 1 is a block diagram illustrating an internal block of a multi-channel spatio-temporal transformer based sign language generation device according to an embodiment of the present disclosure.

FIG. 2 is a block diagram illustrating an internal block of a multi-channel spatio-temporal decoder of FIG. 1.

FIG. 3 is a diagram illustrating a detailed configuration of a sign language generation device of FIG. 1.

FIG. 4 is a diagram for describing a spatial attention module operation of FIG. 2.

FIG. 5 is a diagram for describing a temporal attention module operation of FIG. 2.

FIG. 6 is a flowchart illustrating an operation of a multi-channel spatio-temporal transformer-based sign language generation device according to an embodiment of the present disclosure.

### DETAILED DESCRIPTION OF THE PREFERRED EMBODIMENT

A detailed description of the present disclosure, which will be described later, refers to the accompanying drawings, which illustrate specific embodiments in which the present disclosure may be practiced as examples. These examples are described in detail to be sufficient for those skilled in the art to practice the present disclosure. It should be understood that the various embodiments of the present disclosure are different from each other but need not be mutually exclusive. For example, certain shapes, structures, and characteristics described herein may be implemented in other embodiments without departing from the spirit and scope of the present disclosure with respect to one embodiment. It should also be understood that the position or arrangement of individual components within each disclosed embodiment may be altered without departing from the spirit and scope of the present disclosure. Accordingly, the detailed description to be described below is not intended to be taken in a limited sense, and the scope of the present disclosure, if properly described, is limited only by the appended claims along with all the scope equivalent to those claimed by the claims. Similar reference numerals in the drawings refer to the same or similar functions across several aspects.

The components according to the present disclosure are components defined by functional classification rather than physical classification, and may be defined by functions performed by each. Each component may be implemented as hardware or a program code with a processing unit that performs each function, and functions of two or more components may be included in one component to be implemented. Accordingly, it should be noted that the names given to the components in the following embodiments are not intended to physically distinguish each component, but are given to imply a representative function in which each component is performed, and the technical spirit of the present disclosure is not limited by the names of the components.

Hereinafter, exemplary embodiments of the present disclosure will be described in more detail with reference to the drawings.

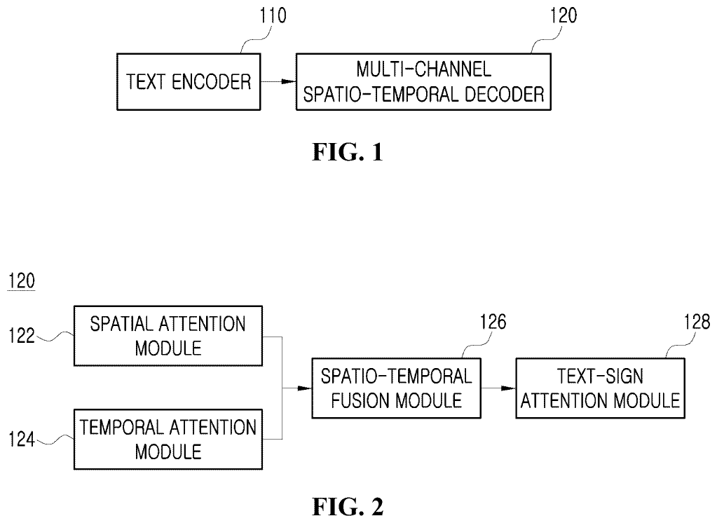

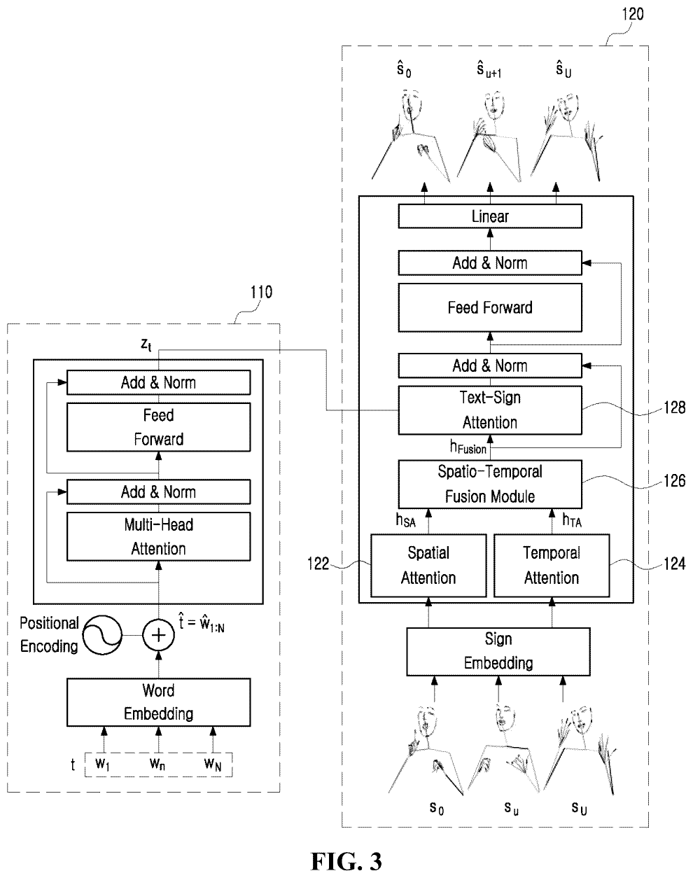

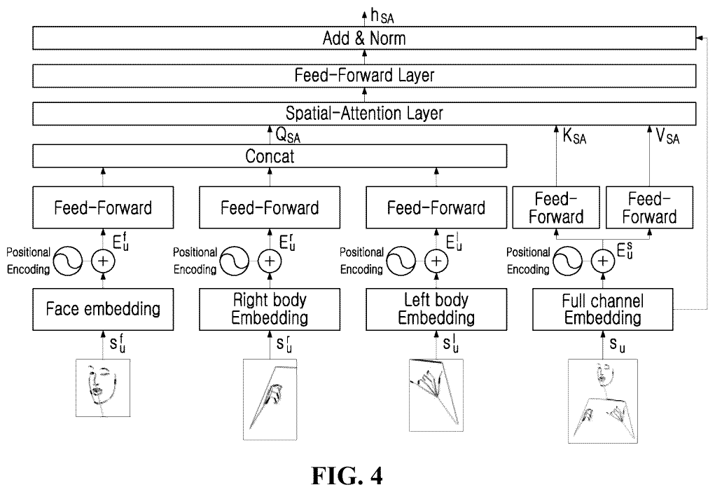

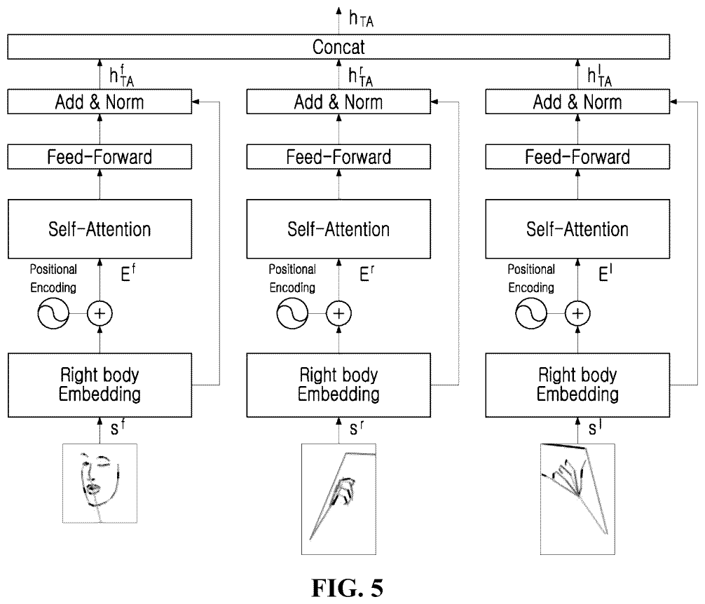

FIG. 1 is a block diagram illustrating the internal block of a multi-channel spatio-temporal transformer based sign language generation device according to an embodiment of the present disclosure, FIG. 2 is a device diagram illustrating an internal block of a multi-channel spatio-temporal decoder of FIG. 1, FIG. 3 is a diagram illustrating a detailed configuration of the sign language generation device of FIG. 1, FIG. 4 is a diagram for explaining a spatial attention module operation of FIG. 2, and FIG. 5 is a diagram for explaining a temporal attention module operation of FIG. 2.

The illustrated sign language generation device includes a text encoder 110 and a multi-channel spatio-temporal decoder 120.

The text encoder 110 inputs a text sequence prepared in advance to at least one encoder block to output a contextual feature.

The multi-channel spatio-temporal decoder 120 extracts a spatial attention feature and a temporal attention feature from a pre-prepared sign pose sequence, inputs the spatial/temporal attention feature and the contextual feature output from the text encoder 110 to at least one module, and outputs a full-channel sign pose sequence including multiple channels for each body part for implementing a sign language operation.

Here, the multi-channel spatio-temporal decoder 120 includes a spatial attention module 122, a temporal attention module 124, a spatio-temporal fusion module 126, and a text-sign attention module 128 as shown in FIG. 2.

Referring to FIG. 3 in more detail, the text encoder 110 includes at least one encoder block, and learns the contextual feature(s) of a text sequence. That is, the text encoder 110 word-embeds a text sequence t=w_{1:N} composed of at least one word, and generates a text sequence representation by adding Positional Encodings (PE) corresponding to the word-embedded text sequence. Here, PE is derived from a predefined sinusoidal function, and indicates order information of words in a text sequence.

The text encoder 110 then generates a contextual feature zₜ that can be formulated as Equation 1 below through the stack of encoder blocks, wherein the text sequence representation is \hat{t}=ŵ_{1:N}.

$${z}_{t} = Encoder ( {\hat{w}}_{n} \vert {\hat{w}}_{1 : N} ) \qquad Equation 1$$

The purpose of the multi-channel spatio-temporal decoder 120 is to generate a full-channel sign pose sequence. That is, the multi-channel spatio-temporal decoder 120 predicts the full-channel sign pose sequence in an autoregressive manner by using the spatial/temporal attention features extracted from the previous sign pose sequence and the contextual features output from the text encoder 110.

The full-channel sign pose represented by sᵤ is composed of 120 keypoints, and is classified into multiple channels for each body part, such as a face channel, a left body channel, and a right body channel. Here, the face channel includes 72 keypoints for the face and neck, and the left body channel and the right body channel include 24 keypoints for the shoulders, arms, and hands of each side.

The multi-channel spatio-temporal decoder 120 embeds a sign pose for each of the face channel, the left body channel, the right body channel, and the full channel, and adds a Positional Encoding (PE) to the embedded sign pose to generate an embedding representation for each channel. The entire embedding process may be formulated as shown in Equations 2 to 3 below.

$${E}_{u}^{8} = P {E}_{s} = P o s i t i o n E n c o d i n g ( {W}^{( s , E )} \cdot {s}_{u} ) \qquad Equation 2$$

$${E}_{u}^{i} = P {E}_{i} = P o s i t i o n E n c o d i n g ( {W}^{( i , E )} \cdot {s}_{u}^{i} \qquad Equation 3$$

Here,

$${s}_{u}^{i}$$

may be

$${s}_{u}^{f} or {s}_{u}^{l} \cdot {s}_{u}^{r}$$

represents a face channel sign pose,

$${s}_{u}^{l}$$

represents a left body channel sign pose,

$${s}_{u}^{r}$$

represents a right body channel sign pose, and sᵤ represents a full-channel sign pose. In addition, PE is derived from a predefined sinusoidal function, and represents position information for each pose.

As shown in FIG. 4, the spatial attention module 122 of the multi-channel spatio-temporal decoder 120 calculates a query by inputting embedding expressions

$${E}_{u}^{f} , {E}_{u}^{r} and {E}_{u}^{l}$$

for the face channel, the right body channel, and the left body channel, respectively, to a separate feed-forward layer, and derives a final query Q_{SA} by concatenating the queries calculated in the respective channels. At the same time, the spatial attention module inputs the embedding representation

$${E}_{u}^{s}$$

for the full channel into two feed forward layers to derive a key K_{SA} and a value V_{SA}.

Thereafter, the spatial attention module 122 inputs Q_{SA}, K_{SA}, and V_{SA} into a spatial-attention layer to calculate a spatial relationship between a sign pose for each channel and a full-channel sign pose to generate a spatial attention feature h_{SA}. The entire process of the spatial attention module 122 may be formulated as shown in Equations 4 to 7 below.

$${Q}_{S A} = C o n c a t ( {W}^{( f , Q )} \cdot {E}_{u}^{f} , {W}^{( {l}_{u} Q )} \cdot {E}_{u}^{l} , {W}^{( r , Q )} \cdot {E}_{u}^{r} ) \qquad Equation 4$$

$${K}_{S A} = {W}^{( s , K )} \cdot {E}_{u}^{s} \qquad Equation 5$$

$${V}_{S A} = {W}^{( s , V )} \cdot {E}_{u}^{s} \qquad Equation 6$$

$${h}_{S A} = softmax ( \frac{{Q}_{S A} \cdot {K}_{S A}^{T}}{\sqrt{{d}_{k}}} ) {V}_{S A} \qquad Equation 7$$

Here, dₖ represents the dimension of full channel embedding, and at this time, the masking method is adjusted to focus only on related past inter-channel information.

The temporal attention module 124 of the multi-channel spatio-temporal decoder 120 is designed to capture the temporal dynamics of each of the face channel, the right body channel, and the left body channel as shown in FIG. 5.

That is, the temporal attention module 124 inputs the embedding representation Eⁱ for each of the face channel, the right body channel, and the left body channel into the self-attention layer to derive the key Kⁱ, the query Qⁱ, and the value Vⁱ as shown in Equations 8 to 10 below.

$${K}^{i} = {W}^{( i , K )} \cdot {E}^{i} \qquad Equation 8$$

$${Q}^{i} = {W}^{( i , Q )} \cdot {E}^{i} \qquad Equation 9$$

$${V}^{i} = {W}^{( i , V )} \cdot {E}^{i} \qquad Equation 10$$

Here, W^{(i,k)}, W^{(i,Q)}, and W^{(i,V)} represent a learnable weight matrix for channel i, and Eⁱ represents an embedding representation for channel i and may be E^{f}, Eⁱ, or E^{r}.

In this way, the temporal attention module 124 calculates the time dependency by applying the self-attention mechanism to each channel, and generates the time attention feature h_{TA}ⁱ for each channel based on Kⁱ, Qⁱ, and Vⁱ as shown in Equation 11 below. The temporal attention module then connects the time attention features, i.e.,

$${h}_{T A}^{f} , {h}_{T A}^{l} and {h}_{T A}^{r}$$

for each channel to generate a time attention feature, i.e., a fine-grained time pattern, as shown in Equation 12 below. In this case, dedicated masking is applied to each self-attention operation in order to prevent information leakage from a subsequent frame.

$${h}_{T A}^{i} = softmax ( \frac{{Q}^{i} \cdot {( {K}^{i} )}^{T}}{\sqrt{{d}_{k}^{i}}} ) {V}^{i} \qquad Equation 11$$

$${h}_{T A} = C o n c a t ( {h}_{T A}^{i} ) \qquad Equation 12$$

Here,

$${d}_{k}^{i}$$

represents a feature dimension of channel i.

Meanwhile, the spatio-temporal fusion module 126 of the multi-channel spatio-temporal decoder 120 applies the following fusion method to better integrate spatial and temporal features.
1) Parallel addition fusion method: The spatial attention module and the temporal attention module are simultaneously operated to fuse the extracted spatial attention feature and temporal attention feature through addition. The parallel additional fusion method imparts the same importance to both the spatial attention feature and the temporal attention feature.
2) Sequential operation fusion method: An output of a temporal attention module is used as an input of the spatial attention module to fuse the spatial attention feature and the time attention feature. The sequential operation fusion method is suitable for scenarios where the processing order of the attention features is important because the spatial attention features are determined according to the previous temporal attention features.
3) Gating fusion method: Apply a gating mechanism to dynamically fuse temporal attention features and spatial attention features. Here, the gating mechanism may be formulated as shown in Equation 13 below.

$$gate = σ ( {W}_{1} \cdot {h}_{T A} + {W}_{2} \cdot {h}_{s A} + b ) \qquad Equation 13$$

Here, W₁ and W₂ represent a weight matrix, and b represents a bias vector of a linear layer. The gate used thereafter is used to evaluate the temporal attention feature and the spatial attention feature and may be formulated as shown in Equation 14 below.

$${h}_{Fusion} = ( 1 - gate ) ⊙ {h}_{s A} + gate ⊙ {h}_{T A} \qquad Equation 14$$

The fusion feature h_{Fusion} generated through the patio-temporal fusion module 126 is input to the text-sign attention module 128. The text-sign attention module 128 aligns the fusion feature with the contextual feature output from the encoder 110, and inputs it into the feed forward layer and the linear layer to predict the full-channel sign pose sequence.

In this case, the multi-channel spatio-temporal decoder 120 is trained using a Mean Square Error (MSE) loss calculated between the predicted sign pose sequence and the ground truth sign pose sequence as shown in Equation 15 below.

$$L = \frac{1}{U} {\sum }_{i = 1}^{U} {( {s}_{i} - {\hat{s}}_{i} )}^{2} \qquad Equation 15$$

Here, [symbol] represents the predicted sign pose sequence, and sᵢ represents the actual sign pose sequence.

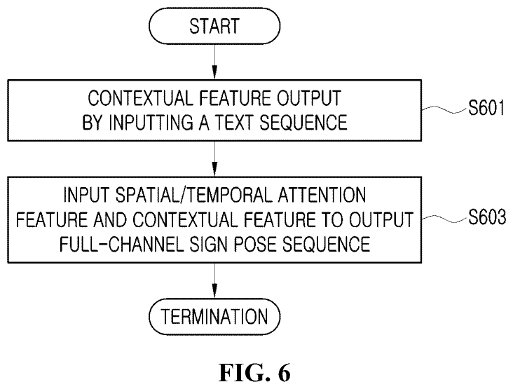

FIG. 6 is a flowchart illustrating an operation of a multi-channel spatio-temporal transformer based sign language generation device based on a multi-channel spatio-temporal transformer according to an embodiment of the present disclosure.

The text encoder of the sign language generation device outputs contextual features by inputting a pre-prepared text sequence into at least one encoder block. (S601)

The multi-channel spatio-temporal decoder of the sign language generation device inputs the spatial/temporal attention feature and the contextual feature output from the S601 to at least one module, and outputs a full-channel sign pose sequence including multiple channels for each body part for implementing the sign language operation. (S603)

The multi-channel spatio-temporal transformer based sign language generating method of the present disclosure may be implemented in the form of program instructions that may be executed through various computer components and recorded in a computer-readable recording medium. The computer-readable recording medium may include program instructions, data files, data structures, and the like alone or in combination.

The program instructions recorded in the computer-readable recording medium may be specially designed and configured for the present disclosure or may be known to and used by those skilled in the field of computer software.

Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions such as a ROM, a RAM, a flash memory, and the like.

Examples of program instructions include not only machine language codes such as those generated by a compiler, but also high-level language codes that may be executed by a computer using an interpreter or the like. The hardware device may be configured to operate as one or more software modules to perform processing according to the present disclosure, and vice versa.

Although various embodiments of the present disclosure have been illustrated and described above, the present disclosure is not limited to the specific embodiments described above, and various modifications can be made by a person skilled in the art to which the present disclosure belongs without departing from the gist of the present disclosure claimed in the claims, and such modifications should not be individually understood from the technical spirit or the prospect of the present disclosure.

### DESCRIPTION OF SYMBOLS

110: text encoder
120: multi-channel spatio-temporal decoder
122: spatial attention module
124: temporal attention module
126: spatio-temporal fusion module
128: text-sign attention module

1. A multi-channel spatio-temporal transformer based sign language generation device, the sign language generation device comprising:
a text encoder configured to output a contextual feature by inputting a text sequence prepared in advance into at least one encoder block; and
a multi-channel spatio-temporal decoder configured to:
extract a spatial attention feature and a temporal attention feature from a sign pose sequence prepared in advance,
input the spatial attention feature, the temporal attention feature and the contextual feature output from the text encoder into at least one processor, and
output a full-channel sign pose sequence including a multiple channel for each body part to implement a sign language operation.

2. The sign language generation device of claim 1, wherein the multi-channel spatio-temporal decoder comprises:
a spatial attention processor configured to output the spatial attention feature between the multiple channel and a full channel;
a temporal attention processor configured to output the temporal attention feature for each of the multiple channel;
a spatio-temporal fusion processor configured to fuse the spatial attention feature and the temporal attention feature to output a fusion feature; and
a text-sign attention processor configured to align the contextual feature and the fusion feature.

3. The sign language generation device of claim 1,
wherein the text encoder is configured to generate a text sequence representation by performing word-embedding on the text sequence and adding a Positional Encoding (PE) corresponding to the word-embedded text sequence, and
wherein the PE is derived from a predefined sinusoidal function.

4. The sign language generation device of claim 2,
wherein the multi-channel spatio-temporal decoder is configured to generate an embedding representation for each of a face channel, a left body channel, a right body channel, and the full channel by embedding a sign pose for each of the face channel, the left body channel, the right body channel, and the full channel, and adding a Positional Encoding (PE) to the embedded sign pose, and
wherein the PE represents time information for a corresponding channel sign pose inference.

5. The sign language generation device of claim 4, wherein the spatial attention processor is configured to generate the spatial attention feature by calculating a spatial relationship between the sign pose and a full-channel sign pose for each of the face channel, the left body channel, the right body channel, and the full channel by inputting into a spatial attention layer:
a final query derived by concatenating a query calculated from the embedding representation for each of the face channel, the left body channel, and the right body channel, and
a key and a value derived from the embedding representation for the full channel.

6. The sign language generation device of claim 4, wherein the temporal attention processor is further configured to:
input the embedding representation of the face channel, the left body channel, and the right body channel into a self-attention layer to derive a query, a key, and a value for each of the face channel, the left body channel, and the right body channel,
calculate time dependency for each of the face channel, the left body channel, and the right body channel based on the derived query, the derived key, and the derived value to generate a time attention feature, and
connect the time attention feature for each of the face channel, the left body channel, and the right body channel to generate the time attention feature.

7. The sign language generation device of claim 2, wherein the spatio-temporal fusion processor is configured to generate the fusion feature by applying at least one of:
a parallel addition fusion method that fuses, through addition, the spatial attention feature and the temporal attention feature simultaneously extracted,
a sequential operation fusion method that fuses the spatial attention feature and the temporal attention feature by using an output of the temporal attention processor as an input of the spatial attention processor, and
a gating fusion method that dynamically fuses the temporal attention feature and the spatial attention feature by applying a gating mechanism.

8. A sign language generating method by a multi-channel spatio-temporal transformer based sign language generation device, the sign language generating method comprising:
inputting, by a text encoder, a text sequence prepared in advance into at least one encoder block to output a contextual feature; and
extracting, by a multi-channel spatio-temporal decoder, a spatial attention feature and a temporal attention feature from a sign pose sequence prepared in advance, and inputting, by the multi-channel spatio-temporal decoder, the spatial attention feature, the temporal attention feature and the contextual feature output from the text encoder into at least one processor to output a full-channel sign pose sequence including a multiple channel for each body part to implement a sign language operation.

9. The sign language generating method of claim 8, wherein the multi-channel spatio-temporal decoder comprises:
a spatial attention processor configured to output the spatial attention feature between the multiple channel and a full channel;
a temporal attention processor configured to output the temporal attention feature for each of the multiple channel;
a spatio-temporal fusion processor configured to fuse the spatial attention feature and the temporal attention feature to output a fusion feature; and
a text-sign attention processor configured to align the contextual feature and the fusion feature.

10. The sign language generating method of claim 8, wherein the outputting of the contextual feature includes generating a text sequence representation by:
word-embedding the text sequence, and
adding a Positional Encoding (PE) corresponding to the text sequence that is word-embedded, wherein the PE is derived from a predefined sinusoidal function.

11. The sign language generating method of claim 9, wherein the outputting of the full-channel sign pose sequence includes generating an embedding representation for each of a face channel, a left body channel, a right body channel, and the full channel by:
embedding a sign pose for each of the face channel, the left body channel, the right body channel, and the full channel, and
adding a Positional Encoding (PE) to the embedded sign pose, wherein the PE represents time information for a channel sign pose inference.

12. The sign language generating method of claim 11, wherein the outputting of the full-channel sign pose sequence further comprises generating the spatial attention feature by calculating a spatial relationship between the sign pose for each of the face channel, the left body channel, the right body channel, and the full channel and a full-channel sign pose by inputting a final query derived by concatenating a query calculated from the embedding representation for each of the face channel, the left body channel, and the right body channel, and a key and a value derived from the embedding representation for the full channel into a spatial attention layer.

13. The sign language generating method of claim 11, wherein the outputting of the full-channel sign pose sequence comprises:
inputting the embedding representation for each of the face channel, the left body channel, and the right body channel into a self-attention layer to derive a query, a key, and a value for each of the face channel, the left body channel and the right body channel;
generating a time attention feature for each of the face channel, the left body channel, and the right body channel based on the derived query, the derived key, and the derived value; and
generating the time attention feature by connecting the time attention feature for each of the face channel, the left body channel and the right body channel.

14. The sign language generating method of claim 9, wherein the outputting of the full-channel sign pose sequence comprises generating the fusion feature by applying at least one of:
a parallel addition fusion method that fuses, through addition, the spatial attention feature and the temporal attention feature simultaneously extracted,
a sequential operation fusion method that fuses the spatial attention feature and the temporal attention feature by using an output of the temporal attention processor as an input of the spatial attention processor, and
a gating fusion method dynamically fuses the temporal attention feature and the spatial attention feature by applying a gating mechanism.

15. A non-transitory recording medium in which a computer program for performing a sign language generating method by a multi-channel spatio-temporal transformer-based sign language generation device is recorded, wherein the sign language generating method comprises:
inputting, by a text encoder, a text sequence prepared in advance into at least one encoder block to output a contextual feature; and
extracting, by a multi-channel spatio-temporal decoder, a spatial attention feature and a temporal attention feature from a sign pose sequence prepared in advance, and inputting, by the multi-channel spatio-temporal decoder, the spatial attention feature, the temporal attention feature and the contextual feature output from the text encoder into at least one processor to output a full-channel sign pose sequence including a multiple channel for each body part to implement a sign language operation.
